(19) United States
(12) Patent Application Publication
(10) Pub. No.: US 2016/0292149 A1
(43) Pub. Date: Oct. 6, 2016

(54) WORD SENSE DISAMBIGUATION USING HYPERNYMS

(71) Applicant: Google Inc., Mountain View, CA (US)

(72) Inventors: Nicolaus Todd Mote, Palo Alto, CA (US); Ryan Patrick Doherty, San Jose, CA (US); Colin Hearne Evans, San Francisco, CA (US)

(21) Appl. No.: 14/450,233

(22) Filed: Aug. 2, 2014

(51) Int. Cl. G06F 17/27

(52) U.S. Cl. CPC G06F 17/2785

(57) ABSTRACT

Methods and apparatus related to word sense disambiguation utilizing hypernyms. In some implementations, one or more senses of a word are determined based on hypernyms for the word and an association of the word to the one or more senses is stored. In some implementations, a target word in a textual segment is identified and a word sense to assign to the target word is determined based on hypernyms that are associated with the target word.

### BACKGROUND

Word sense disambiguation generally relates to resolving the lexical ambiguity that arises when a given word has multiple meanings. For example, the word “bat” may have multiple meanings such as: the animal, the club used for hitting a ball, a turn trying to get a hit, to contact a ball or other object, to wink briefly, etc. Various computer-based approaches have been utilized to disambiguate words that have multiple meanings. For example, some approaches focus on shared vocabulary between the definition of each meaning of a target word to be disambiguated and the words in the neighborhood surrounding the target word (or the definitions of such surrounding words). As one example, consider the segment of text “The bat flapped its wings furiously.” A definition of “bat” related to the “animal” meaning may be “nocturnal mouselike mammal with forelimbs modified to form membranous wings and anatomical adaptations for echolocation by which they navigate.” The meaning of “bat” related to the “animal” may be selected as the correct meaning in the preceding segment of text based on “wings” occurring in the segment of text and occurring in the definition of “bat” related to the “animal” meaning.

### SUMMARY

This specification is directed generally to methods and apparatus related to word sense disambiguation utilizing hypernyms. Some implementations are directed generally toward determining one or more senses of a word based on hypernyms for the word and storing an association of the one or more senses to the word. Some versions of those implementations are directed to determining that a word has only a single sense and associating the one or more senses to the word includes associating the word with an indication that disambiguation of the word is unnecessary. Some implementations are directed toward identifying a target word in a textual segment and determining, based on hypernyms that are associated with the target word, an appropriate word sense to assign to the target word.

In some implementations, a computer implemented method may be provided that includes the steps of: determining a plurality of hypernyms for a word, each of the hypernyms including the word and one or more additional words as associated members; clustering the hypernyms into one or more groups based on similarity measures between the hypernyms; defining one or more senses of the word based on the groups; and storing an association of the word to the senses.

This method and other implementations of technology disclosed herein may each optionally include one or more of the following features.

In some implementations, the word is included as an associated member of a given hypernym of the hypernyms based on one or more syntactic relationships between the given hypernym and the word in one or more resources. In some of those implementations, the resources include one or more of: search queries, webpages, and communications. In some of those implementations, inclusion of the word as an associated member of the given hypernym is factually inaccurate. In some of those implementations, the given hypernym defines a sentiment.

In some implementations, the method further includes determining the similarity measures between the hypernyms. In some of those implementations, determining a similarity measure of the similarity measures between a first hypernym and a second hypernym of the hypernyms is based on a degree of overlap between the additional words of the first hypernym and the additional words of the second hypernym. In some of those implementations, determining a similarity measure of the similarity measures between the first hypernym and the second hypernym is additionally or alternatively based on one or more relationships between the first hypernym and the second hypernym in an entity database. In some of those implementations, determining a similarity measure of the similarity measures between the first hypernym and the second hypernym is additionally or alternatively based on one or more syntactic relationships between the first hypernym and the second hypernym in one or more resources.

In some implementations, the word is included as an associated member of a given hypernym of the hypernyms based on automated process that analyzes relationships between the given hypernym and the word in one or more resources.

In some implementations, clustering the hypernyms into one or more groups includes clustering the hypernyms into a single group; and defining the sense of the word based on the group includes defining the word as having only a single sense based on presence of only the single group for the word. In some of those implementations, storing the association of the word to the senses includes associating the word with an indication that disambiguation of the word is unnecessary.

In some implementations, a given sense of the senses is defined based on a given group of the groups and storing the association of the word to the senses includes storing an association of the given sense with the hypernyms of the given group.

In some implementations, the method further includes: identifying a textual segment including the word and a plurality of additional segment words; and selecting one sense of the senses for the word in the textual segment based on the stored association of the word to the senses. In some of those implementations, selecting the one sense for the word in the textual segment based on the stored association of the word to the senses includes: determining a subset of the hypernyms for the word based on an association of one or more of the additional segment words to the hypernyms of the subset; and selecting the one sense based on the subset. In some of those implementations, the one sense of the senses is defined based on a given group of the groups and storing the association of the word to the senses includes storing an association of the one sense with the hypernyms of the given group; and selecting the one sense based on the subset includes selecting the one sense based on the hypernyms of the subset being included in the hypernyms of the given group associated with the one sense. In some of those implementations, determining a subset of the hypernyms for the word based on an association of one or more of the additional segment words to the hypernyms of the subset comprises: determining additional word hypernyms for one or more of the additional segment words; determining the subset of the hypernyms based on one or both of: one or more of the additional word hypernyms matching one or more of the hypernyms of the subset; and one or more of the additional word hypernyms having at least a threshold similarity measure relative to one or more of the hypernyms of the subset.

In some implementations, a computer implemented method may be provided that includes the steps of: identifying a textual segment including a target word and a plurality of additional words; determining a group of one or more hypernyms associated with a sense of the target word and associated with one or more of the additional words; and selecting a sense for the target word based on the group.

This method and other implementations of technology disclosed herein may each optionally include one or more of the following features.

In some implementations, the method further includes: determining target hypernyms for the target word, each of the target hypernyms including the word as an associated member; and determining one or more similarity measures between the target hypernyms fail to satisfy a threshold; wherein selecting the sense for the target word based on the group is based on the similarity measures failing to satisfy the threshold.

In some implementations, determining the group of the one or more hypernyms associated with a sense of the target word and associated with one or more of the additional words includes: determining at least a first hypernym of the hypernyms of the group based on the hypernym being one of the additional words.

In some implementations, determining the group of the one or more hypernyms associated with a sense of the target word and associated with one or more of the additional words includes: determining at least a first hypernym of the hypernyms of the group based on the hypernym being a hypernym of one of the additional words.

In some implementations, determining the group of the one or more hypernyms associated with a sense of the target word and associated with one or more of the additional words includes: determining at least a first hypernym of the hypernyms of the group based on the hypernym being a hypernym of one or more definitional words in a sense definition of one of the additional words.

In some implementations, determining the group of the one or more hypernyms associated with a sense of the target word and associated with one or more of the additional words includes: determining at least a first hypernym of the hypernyms of the group has a similarity measure that satisfies a threshold, the similarity measure indicative of similarity between the first hypernym and a second hypernym that is associated with one or more of the additional words; wherein the second hypernym is not included in the group. In some of those implementations, the similarity measure is a distance measure in an embedding of hypernyms in a k-dimensional space. The embedding of the hypernyms in the k-dimensional space may be learned based on relationships between the hypernyms and the target word in one or more resources.

In some implementations, determining the group of the one or more hypernyms associated with a sense of the target word and associated with one or more of the additional words includes: determining the hypernyms are associated with the sense of the target word based on the hypernyms including one or more definitional words in a definition of the sense of the target word.

In some implementations, determining the group of the one or more hypernyms associated with a sense of the target word and associated with one or more of the additional words includes: determining the hypernyms are associated with the sense of the target word based on the hypernyms being included in a definition of the sense of the target word.

Other implementations may include a non-transitory computer readable storage medium storing instructions executable by a processor to perform a method such as one or more of the methods described above. Yet another implementation may include a system including memory and one or more processors operable to execute instructions, stored in the memory, to perform a method such as one or more of the methods described above.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

### BRIEF DESCRIPTION OF THE DRAWINGS

FIG. 1 illustrates an example environment in which one or more senses of a word may be determined and/or a sense for a target word in a textual segment may be determined.

FIG. 2 illustrates an example of how one or more senses of a word may be determined based on hypernyms for the word.

FIG. 3A illustrates an example of a word “humanoid” and example hypernyms for that word.

FIG. 3B illustrates the example hypernyms of FIG. 3A clustered in two groups based on similarity measures between the hypernyms.

FIG. 4 is a flow chart illustrating an example method of determining one or more senses of a word based on hypernyms for the word.

FIG. 5 illustrates an example of how a sense for a target word in a textual segment may be determined.

FIG. 6A illustrates an example of a textual segment and example senses and hypernyms associated with the textual segment.

FIG. 6B illustrates another example of a textual segment and example senses and hypernyms associated with the textual segment.

FIG. 6C illustrates another example of a textual segment and example sense definitional terms and hypernyms associated with the textual segment

FIG. 7 is a flow chart illustrating an example method of determining a sense for a target word in a textual segment.

FIG. 8 illustrates an example architecture of a computer system.

### DETAILED DESCRIPTION

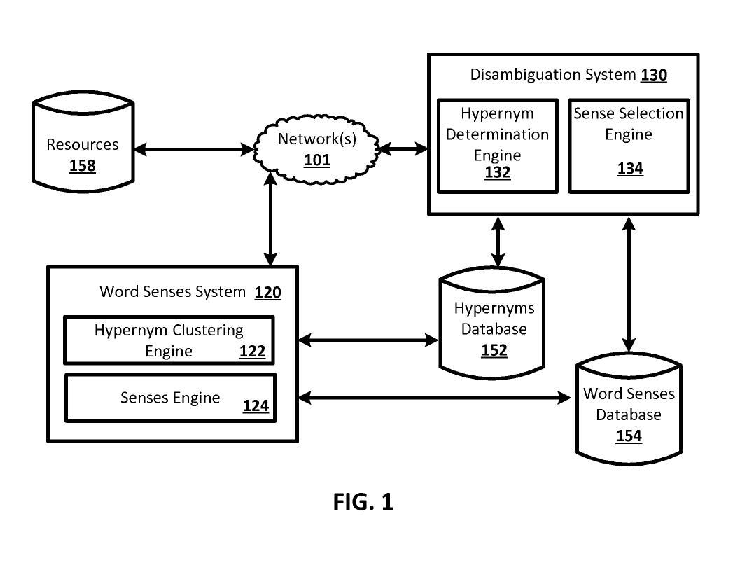

FIG. 1 illustrates an example environment in which one or more senses of a word may be determined and/or a sense for a target word in a textual segment may be determined. The example environment includes a word senses system 120 and a disambiguation system 130. Word senses system 120 and disambiguation system 130 may each be implemented in one or more computers that communicate, for example, through a network (not depicted). Word senses system 120 and disambiguation system 130 are example systems in which the systems, components, and techniques described herein may be implemented and/or with which systems, components, and techniques described herein may interface.

Word senses system 120 and disambiguation system 130 each include one or more memories for storage of data and software applications, one or more processors for accessing data and executing applications, and other components that facilitate communication over a network. The operations performed by word senses system 120 and/or disambiguation system 130 may be distributed across multiple computer systems.

Word senses system 120 determines one or more senses of a word based on hypernyms for the word and stores an association of the one or more senses to the word in word senses database 154. Generally, each sense of a word defines a meaning of the word. Disambiguation system 130 identifies a target word in a textual segment and determines, based on hypernyms that are associated with the target word in the context of the textual segment, an appropriate word sense to assign to the target word. As described in more detail herein, in some implementations of disambiguating a word, disambiguation system 130 may utilize senses and/or hypernyms that have been associated with the word by word senses system 120 utilizing techniques described herein. In some other implementations of disambiguating a word, disambiguation system 130 may utilize senses and/or hypernyms that are or have been associated with the word independent of techniques described herein with respect to word senses system 120.

Word senses system 120 and disambiguation system 130 may each utilize hypernyms database 152 and/or other databases or resources in determining hypernyms for words. Generally, as used herein, a hypernym is a word that defines a class of which multiple other words (hyponyms) are associated members. For example, “animal” is a hypernym of “bird” and “bird” is a hypernym of “eagle.”

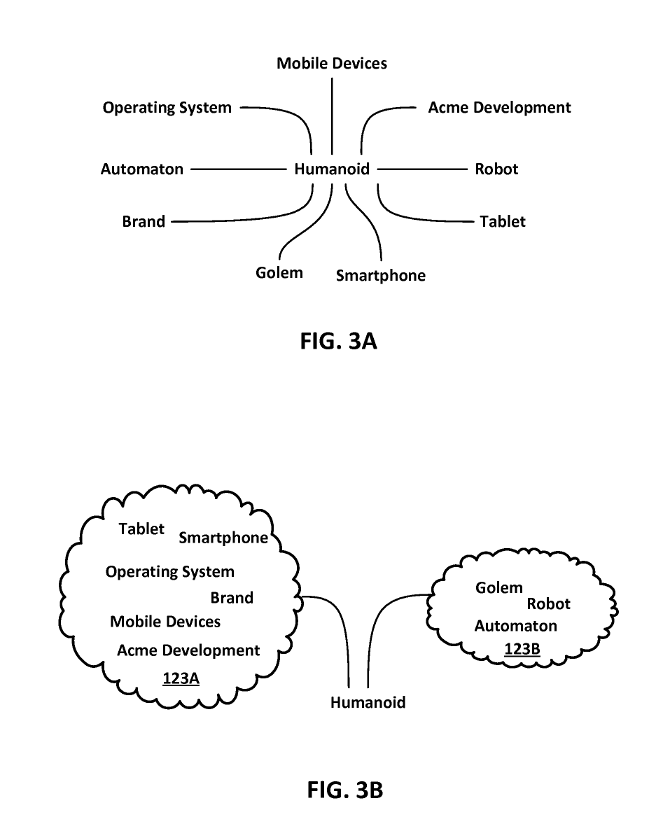

Generally, hypernyms database 152 includes identifiers of a collection of words and defined hypernym/hyponym relationships for the words. FIG. 3A illustrates an example of words and relationships that may be included in hypernyms database 152. In FIG. 3A, the word “humanoid” is illustrated with examples of some hypernyms for the word “humanoid”. Uses of “humanoid” herein may refer to the meaning of “a robot that resembles a human being” or a fictional meaning of “humanoid” used for illustrative purposes. Under the fictional meaning used herein, “humanoid” is a mobile operating system developed by Acme. The relationships of “humanoid” to the hypernyms are represented in FIG. 3 by lines extending between the word “humanoid” and the hypernyms. In this specification “word” may be utilized to refer to only a single term (e.g., “humanoid”) and/or to multiple terms (e.g., “operating system”), depending on the context. For example, some words in hypernyms database 152 may include only a single term, while other words may include two or more terms.

The hypernyms database 152 may optionally include additional information related to the relationships between the hypernyms and associated hyponyms, the relationships between hypernyms, and/or the relationships between hyponyms. For example, in some implementations a word may be associated with multiple hypernyms and each of the associations may include a weight indicating the strength of the association of the word to the hypernym. For instance, with reference to FIG. 3A, the association of “humanoid” to “operating system” may optionally be associated with a first weight that is greater than a second weight optionally associated with the association of “humanoid” to “tablet”. In some implementations, the strength of the association between a word and a hypernym for the word may be based on frequency of co-occurrence of the word and the hypernym in one or more resources, such as resources of resources database 158.

As another example of additional information that may be included in hypernyms database 152, similarity measures between hypernyms may be included that provide an indication of the strength of relationships between hypernyms. For instance, with reference to FIG. 3A, a first similarity measure between “mobile device” and “smartphone” may be more indicative of similarity than a second similarity measure between “smartphone” and “automaton”. The similarity measure between two hypernyms may be based on one or more factors such as, for example, semantic similarity between the hypernyms, hyponym(s) shared (or not shared) between the hypernyms, syntactic relationships between the hypernyms in one or more resources, and/or relationship(s) between the hypernyms in an entity database (e.g., a knowledge graph). For example, a similarity measure between a first hypernym and a second hypernym of the hypernyms may be determined based on a degree of overlap between the hyponyms of the first hypernym and the hyponyms of the second hypernym and/or relationship(s) between the first and second hypernyms in an entity database. In some implementations, the word senses system 120 may determine similarity measures between hypernyms. In some other implementations, a separate component may determine such similarity measures.

In some implementations, the hypernyms database 152 and/or another database includes an embedding of hypernyms in a k-dimensional space and the similarity measures are based on distance measures between the hypernyms in the k-dimensional space. In some versions of those implementations, the embedding in the k-dimensional space is learned based on semantic, syntactic, and/or other relationships between the hypernyms. The learned embedding in the k-dimensional space may provide increased coverage of similarity measures between hypernyms. For example, the relationships utilized to learn the embedding in the k-dimensional space may not directly define a relationship between hypernym A and hypernym C. However, once embedded into the k-dimensional space, a distance measure between hypernyms A and C may be utilized to determine a similarity measure between hypernyms A and C. One or more aspects of hypernyms database 152 may be updated on a periodic or other basis to identify new words, new relationships between words, and/or update similarity measures between words based on new resources and/or previously unexamined resources. In some implementations, a separate component may optionally maintain one or more aspects of hypernyms database 152.

In some implementations of techniques described herein, one or more hyponyms of a hypernym may have a true taxonomical relationship to the hypernym. In other words, one or more of the hyponyms may have a factually provable “is-a” relationship to the hypernym. For example, one or more hyponyms of a hypernym may have a semantic field that is included within that of the hypernym. For instance, “bird” may be a hypernym of “eagle” and the semantic field of an “eagle” is included within that of “bird”.

In some implementations of techniques described herein, one or more hyponyms of a hypernym may be “weakly typed” and fail to have a true taxonomical relationship to the hypernym. For example, in some implementations one or more hyponyms may be a member of a hypernym based on identified syntactic or other relationships to the hypernym—without necessarily having a semantic field that is include within that of the hypernym. For instance, hyponyms of hypernyms may include those that are “factually inaccurate” and/or those that express sentiment or other information that is not necessarily factually provable. As one example of a hyponym of a hypernym that is factually inaccurate, “spider” may be a hyponym of “insects” based on their co-occurrence in resources such as resources that include text segments of: “spiders are insects”, “insect-like spider”, etc. As another example of a hyponym of a hypernym that is factually inaccurate, “fish” may be a hyponym of “dolphin” based on their co-occurrence in resources such as resources that include text segments of: “dolphins are my favorite fish”, “We saw a plethora of fish including sharks, dolphins, and barracudas.”, etc. Some examples of hyponyms of hypernyms that are not factually provable include “evil company” as a hyponym of “Company A”, “great movie” as a hyponym of “Movie B”, “good” as a hyponym of “Company C”, and “overpriced” as a hyponym of “Product A”.

Such “weakly typed” hyponym/hypernym relationships may be utilized in word sense disambiguation techniques described herein even though they lack a true taxonomical relationship. For example, if a text segment includes “The spider was one of the most beautiful insects I had seen”, it may be useful to determine “spider” in the segment refers to the “arachnid” sense (and not another sense such as the sense associated with the ALFA ROMEO car by the same name) based on presence of the hypernym “insect” (which may be associated with an “arachnid” sense of “spider” per techniques described herein). Also, for example, if a text segment includes “Shows about dolphins or sharks are my favorite things to watch”, it may be useful to determine “dolphins” in the segment refers to the “mammal” sense (and not another sense such as the sense associated with the Miami football team by the same name) based on presence of the word “sharks” (which may be associated with a hypernym of “fish” which, in turn, may be associated with a “mammal” sense of “dolphins” per techniques described herein).

Additionally, for example, such “weakly typed” hyponym/hypernym relationships may be useful in determining new senses of a word, defining senses of a relatively new word, and/or determining an increased or decreased granularity of senses for a word than those defined in certain word sense dictionaries. For instance, manually curated word sense dictionaries that enumerate different senses of a word may fail to contain a new sense of a word, may fail to contain an entry for a relatively new word, may contain fewer senses of a word than may be desired for some implementations of word sense disambiguation, and/or may contain more senses of a word than may be desired for some implementations of word sense disambiguation.

In some implementations, a word may be included as an associated member of a given hypernym based on one or more automated process that analyze syntactic or other relationships between the hypernym and the word in one or more resources such as resources in resources database 158. Resources database 158 and/or other database may contain one or more storage mediums that include resources such as web pages, “DOC” documents, “PDF” documents, search queries, communications (e.g., emails, tweets, instant messages, social network postings), etc. Such automated analysis of resources may enable defining a sense of a word, and/or sense(s) of a new word, without requiring the sense and/or word be explicitly defined in an electronic dictionary. In some implementations, a word that fails to have a true taxonomical relationship to a hypernym may be identified as a hyponym of that hypernym based on co-occurrence of the hyponym and hypernym in resources. For example, a word may be identified as a hyponym of a hypernym based on the word and the hypernym being within a threshold word distance of one another in one or more resources, having one or more syntactic relationships to one another in one or more resources, participating in the same and/or similar n-grams in one or more resources (e.g., “birds have feathers and wings” and “eagles have feathers and wings”), participating in particular n-grams in one or more resources (e.g., an n-gram of the form “[word] is a type of [hypernym]”, and/or based on other relationship(s) between the word and the hypernym in one or more resources. For instance, the word “twerking” may be identified as a hyponym of “dancing” based on segments of text in one or more resources such as: “Twerking is a type of dancing.”

Word senses system 120 determines one or more senses of a word based on hypernyms for the word and stores an association of the one or more senses to the word in word senses database 154. In various implementations, word senses system 120 may include a hypernym clustering engine 122 and a senses engine 124. In some implementations, all or aspects of engine 122 and/or engine 124 may be omitted. In some implementations, all or aspects of engine 122 and/or engine 124 may be combined. In some implementations, all or aspects of engine 122 and/or engine 124 may be implemented in a component that is separate from word senses system 120.

Generally, for a given word, hypernym clustering engine 122 determines a plurality of hypernyms for the word and clusters the hypernyms into one or more groups based on similarity measures between the hypernyms. In some implementations, only direct hypernyms for the word may be utilized. In some implementations direct hypernyms and higher level hypernyms may both be utilized. Also, as described above, in some implementations one or more of the hypernyms for the word may fail to have a true taxonomical relationship to the hypernym. Each of the groups determined by hypernym clustering engine 122 corresponds to a different sense of the word. The hypernyms clustered in a given group for a word will be more similar to one another (e.g., based on the similarity measures) than to the hypernyms clustered in other groups for the word. For example, the hypernym clustering engine 122 may cluster hypernyms of “humanoid” into a first group that includes hypernyms such as “operating system”, “smartphone”, “Acme development”, etc.; and a second group that includes hypernyms such as “robot”, “automaton”, etc. The parameters utilized by the hypernym clustering engine 122 may be set to achieve a desired degree of conformity between the hypernyms of clusters. For example, the similarity function utilized in clustering may be set to achieve desired degrees of similarity between the hypernyms of clusters. In some implementations, the hypernym clustering engine 122 may utilize the same parameters for all words. In some implementations, the hypernym clustering engine 122 may determine parameters based on one or more properties of the word (e.g., part of speech, number of senses defined for the word in an existing dictionary, popularity of the word), the determined hypernyms of the word (e.g., number of hypernyms, popularity of the hypernyms, number of hyponyms that are associated members of the hypernyms), the parameters of desired word sense disambiguation that utilize the senses, and/or other factors.

In some implementations, the hypernym clustering engine 122 may utilize one or more clustering algorithms in clustering the hypernyms into one or more groups based on similarity measures between the hypernyms. For example, in some implementations x-means clustering may be utilized, with the distance between hypernyms being based on the similarity measures between the hypernyms (e.g., the similarity measures included in hypernyms database 152). Generally, x-means clustering is an unsupervised method of finding the ideal k to use for k-means clustering. Generally, k-means clustering aims to partition observations into a plurality of groups, with each observation being included in a group with which it is most related (e.g., based on similarity measures relative to one or more other hypernyms of the group). Additional and/or alternative clustering techniques may optionally be used in clustering the hypernyms into one or more groups based on similarity measures between the hypernyms.

In some implementations, the hypernym clustering engine 122 may not include one or more hypernyms of a word in any group. For example, in some implementations the hypernym clustering engine 122 may determine that one or more hypernyms are outliers based on the hypernyms not having a relationship to any (or more than a threshold number of) other hypernyms of the word. Also, for example, in some implementations the hypernym clustering engine 122 may only include hypernyms that have at least a threshold strength of association to the word (e.g., as indicated by the weights in hypernyms database 152). For example, some hypernyms of a word may only be very weakly associated with that word and may be omitted by the hypernym clustering engine 122 from being included in any group.

Generally, the senses engine 124 defines one or more senses for the word based on the groups and stores an association of the word to the senses in word senses database 154. For example, the senses engine 124 may store a relationship of the word to an indication of each sense in word senses database 154, and optionally store an indication one or more of the hypernyms associated with each sense of the word. For example, the senses engine 124 may define a first sense of “humanoid” that is indicative of the operating system and a second sense of “humanoid” that is indicative of the robot. In some implementations, defining the sense may include defining the sense based on one or more of the hypernyms of the group associated with that sense. For example, the senses engine 124 may optionally store an association of each sense of a word to one or more hypernyms of the group on which the sense is based. For instance, the previously described first sense may be associated with hypernyms such as “operating system”, “smartphone”, “Acme development”, etc.; and the second sense may be associated with hypernyms such as “robot”, “automaton”, etc. In some implementations, defining the sense may include assigning an identifier to the sense (e.g., an entity identifier associated with the sense) and/or generating a definition for the sense (e.g., based on definitions of the hypernyms of the sense for the word, user input, and/or one or more existing definitions associated with the sense in an electronic sense dictionary and/or other dictionary).

In some implementations, hypernym clustering engine 122 may cluster the hypernyms for a word into only a single group based on similarity measures between the hypernyms. In some of those implementations, the senses engine 124 may determine that the word has only a single sense and associating the one or more senses to the word may include associating the word with an indication that disambiguation of the word is unnecessary. In some of those implementations, the hypernym clustering engine 122 may cluster the hypernyms for a word into only a single group even though multiple senses for the word exist in an electronic sense dictionary. For example, in some implementations the hypernym clustering engine 122 may determine only one group of hypernyms for a word even though two or more sense definitions are included for the word in an electronic sense dictionary. An indication that disambiguation of the word is unnecessary may be used by disambiguation system 130 and/or other disambiguation system(s) to determine that it does not need to disambiguate the word. Associating words with indications that disambiguation is unnecessary may save computational resources of disambiguation system 130 by enabling disambiguation system 130 to skip disambiguation of words that are not worth disambiguating.

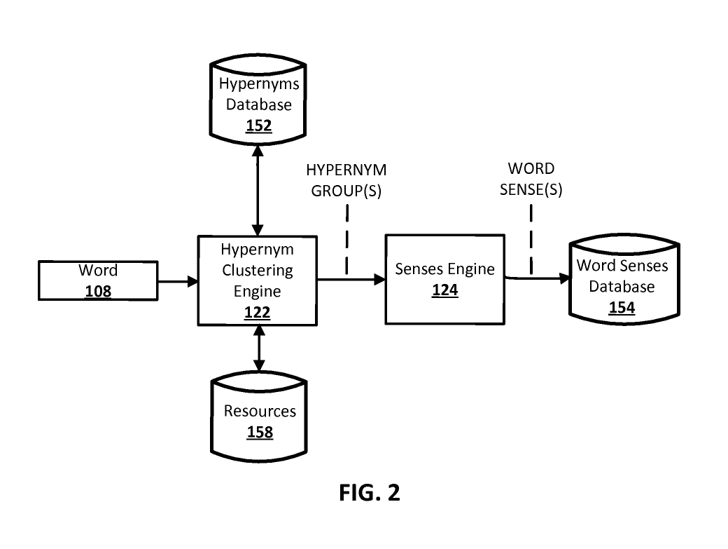

FIG. 2 illustrates an example of how one or more senses of a word may be determined based on hypernyms for the word. Hypernym clustering engine 122 may identify word 108. For example, the hypernym clustering engine 122 may identify the word 108 from hypernyms database 152 or from another source (e.g., from a provided list of words for which senses are to be determined). Hypernym clustering engine 122 determines a plurality of hypernyms for the word 108 from hypernyms database 152. For example, the word 108 may be “humanoid” and the hypernyms illustrated in FIG. 3A may be identified (and optionally additional hypernyms).

The hypernym clustering engine 122 may also identify similarity measures for the hypernyms. In some implementations, the hypernym clustering engine 122 identifies one or more of the similarity measures from hypernyms database 152. In some implementations, the hypernym clustering engine 122 determines one or more of the similarity measures. For example, the hypernym clustering engine 122 may determine a similarity measure between a first hypernym and a second hypernym of the hypernyms based on a degree of overlap between the hyponyms of the first hypernym and the hyponyms of the second hypernym and/or relationship(s) between the first and second hypernyms in an entity database.

The hypernym clustering engine 122 clusters the hypernyms into one or more groups based on similarity measures between the hypernyms and provides the hypernym group(s) to senses engine 124. For example, as illustrated in FIG. 3B, the hypernym clustering engine 122 may cluster hypernyms of “humanoid” into a first group 123A that includes hypernyms such as “operating system”, “smartphone”, “Acme development”, etc.; and a second group 123B that includes the hypernyms “golem”, “robot”, and “automaton”. In some implementations, the hypernym clustering engine 122 may utilize x-means clustering and/or other clustering techniques in clustering the hypernyms into one or more groups based on similarity measures between the hypernyms.

The senses engine 124 defines one or more senses for the word based on the group(s) provided by the hypernym clustering engine 122 and stores an association of the word to the senses in word senses database 154. For example, the senses engine 124 may define a first sense of “humanoid” that is indicative of the operating system and a second sense of “humanoid” that is indicative of the robot. In some implementations, defining a sense may include defining the sense based on one or more of the hypernyms of the group associated with that sense. For example, the sense engine 122 may optionally store an association of each sense of a word to one or more hypernyms of the group on which the sense is based. In some implementations, defining the sense of a word may include assigning an identifier to the sense (e.g., an entity identifier associated with the sense), generating a definition for the sense, and/or determining an existing definition of the word to assign to the sense

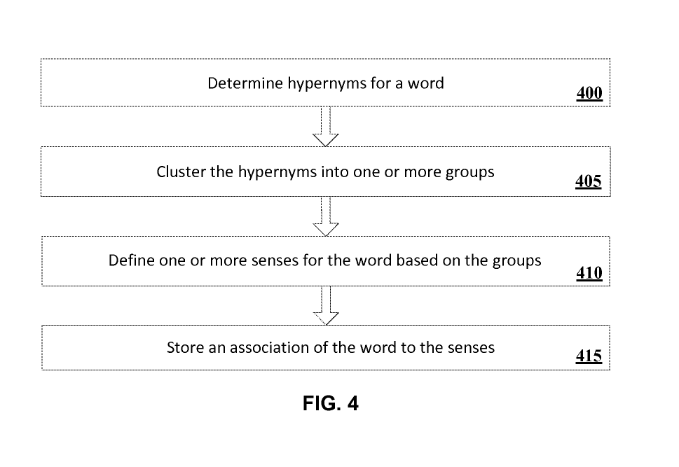

FIG. 4 is a flow chart illustrating an example method of determining one or more senses of a word based on hypernyms for the word. For convenience, the operations of the flow chart are described with reference to a system that performs the operations. This system may include various components of various computer systems. For instance, some operations may be performed by one or more components of the word senses system 120, such as hypernym clustering engine 122 and/or senses engine 124. Moreover, while operations of the method of FIG. 4 are shown in a particular order, this is not meant to be limiting. One or more operations may be reordered, omitted or added.

At step 400, hypernyms are determined for a word. For example, the system may determine a plurality of hypernyms for a word from hypernyms database 152. For instance, the word may be “tesla” and determined hypernyms may include, for example, “person”, “inventor”, “engineer”, “band”, “rock band”, “car brand”, “car manufacturer”, “company”, “American company”, “stock”, etc. As described herein, in some implementations one or more hyponyms for the word may be “weakly typed” and fail to have a true taxonomical relationship to the hypernym. For example, hyponyms of hypernyms may include those that are “factually inaccurate” and/or those that express sentiment or other information that is not necessarily factually provable.

At step 405, the hypernyms are clustered into one or more groups. For example, the system may cluster the hypernyms into one or more groups based on similarity measures between the hypernyms. For example, and continuing with the preceding “tesla” example, the system may cluster hypernyms of “tesla” into a first group that includes hypernyms such as “person”, “inventor”, “engineer”; a second group that includes hypernyms such as “band”, “rock band”; and a third group that includes hypernyms such as “car brand”, “car manufacturer”, “company”, “American company”, “stock”. In some implementations, the system may utilize x-means clustering and/or other clustering techniques in clustering the hypernyms into one or more groups based on similarity measures between the hypernyms.

At step 410, one or more senses are defined for the word based on the groups. For example, the system may define each of the senses based on one or more of the hypernyms of the group associated with the sense. For example, the system may optionally store an association of each sense of a word to one or more hypernyms of the sense for the word. In some implementations, defining the sense may include assigning an identifier to the sense (e.g., an entity identifier associated with the sense) and/or generating or determining a definition for the sense (e.g., based on definitions of the hypernyms of the sense for the word, definition(s) for the word, and/or user input). As one example, and continuing with the preceding “tesla” example, based on the first group the system may define a first sense of “tesla” that is indicative of the inventor Nikola Tesla, based on the second group the system may define a second sense that is indicative of the rock band Tesla, and based on the third group the system may define a third sense that is indicative of the company TESLA MOTORS.

At step 415, an association of the sense to the word is stored. For example, the system may store an association of the word to the sense in word senses database 154.

Referring again to FIG. 1, as described above, disambiguation system 130 identifies a target word in a textual segment and determines, based on hypernyms that are associated with the target word, an appropriate word sense to assign to the target word. In various implementations, disambiguation system 130 may include a hypernym determination engine 132 and a sense selection engine 134. In some implementations, all or aspects of engine 132 and/or engine 134 may be omitted. In some implementations, all or aspects of engine 132 and/or engine 134 may be combined. In some implementations, all or aspects of engine 132 and/or engine 134 may be implemented in a component that is separate from disambiguation system 130.

Generally, for each of one or more senses of a target word in a textual segment, hypernym determination engine 132 determines a group (if any) of one or more hypernyms that are associated with the sense and that are associated with one or more additional words of the textual segment. For example, for a target word that has a first sense and a second sense: hypernyms that are associated with the first sense and have one or more associations to one or more of the additional words may be determined from hypernyms database 152; and hypernyms that are associated with the second sense and have one or more associations to one or more of the additional words may be determined from hypernyms database 152. An association of a hypernym to a sense of a target word may be based on, for example: the techniques describe herein with respect to word senses system 120 (e.g., the word senses system 120 may associate hypernyms of a group with a sense determined based on the group); determining hypernyms of the target word that are the same as one or more definitional words in a sense definition of the target word and/or that have similarity measures with respect to one or more of the definitional words that satisfy a threshold; and/or determining hypernyms of the target word that are the same as one or more hypernyms for definitional words in a sense definition of the word and/or that have similarity measures with respect to one or more hypernyms of the definitional words that satisfy a threshold.

An association of a hypernym to an additional word may be based on, for example, one or more of: the hypernym and the additional word being the same word (optionally utilizing canonicalizations of each); the hypernym and the additional word having a similarity measure therebetween that satisfies a threshold; the hypernym also being a hypernym of the additional word; the hypernym and one or more hypernyms of the additional word having similarity measures therebetween that satisfy a threshold; the hypernym and one or more definitional words in a sense definition of the additional word being the same and/or having similarity measures therebetween that satisfy a threshold; and/or the hypernym and one or more hypernyms in definitional words in a sense definition (or other definition) of the additional word being the same and/or having similarity measures therebetween that satisfy a threshold.

As described above, in some implementations the hypernyms database 152 and/or another database includes an embedding of hypernyms in a k-dimensional space. In some versions of those implementations, similarity measures utilized by hypernym determination engine 132 (if any) in determining one or more hypernyms that are associated with a sense of a word in a textual segment and associated with one or more additional words in the textual segment may be based on distance measures between hypernyms in the k-dimensional space. In some implementations, hypernym determination engine 132 may determine a group of hypernyms that are associated with a sense of a word in a textual segment and associated with one or more additional words in the textual segment based on the k-dimensional space. For example, a first vector indicating the hypernyms of the sense may be generated and a second vector indicating hypernyms associated with the additional words (e.g., hypernyms in: the words themselves, definitional words in a sense definition of the words, and/or hypernyms of the words or definitional words) may also be generated. The vectors may be generated based on the embedding of the hypernyms in the k-dimensional space and compared to one another to determine one or more hypernyms that are associated with the sense and/or to determine similarity measure(s) between the hypernyms (either individual similarity measures or a collective similarity measure). For example, a cross product or a dot product of the two vectors may provide an indication of hypernyms that are associated with the sense and the additional words (if any) and/or the collective similarity between those hypernyms.

Generally, sense selection engine 134 selects a sense for the target word based on the group(s) of hypernyms for the senses determined by hypernym determination engine 132. For example, for a target word that has a first sense and a second sense: hypernym determination engine 132 may have determined a first group of two hypernyms that are associated with the first sense and that have one or more associations to one or more of the additional words; and hypernym determination engine 132 may have determined that there are no hypernyms that are associated with the second sense and that have one or more associations to one or more of the additional words. Based on the first group being associated with the first sense, and being the only group with hypernyms associated with the additional words, the sense selection engine 134 may select the first sense as the sense for the target word.

As another example, for a target word that has a first sense and a second sense: hypernym determination engine 132 may have determined a first group of two hypernyms that are associated with the first sense and that have one or more associations to one or more of the additional words; and hypernym determination engine 132 may have determined a second group of only one hypernym that is associated with the second sense and that has one or more associations to one or more of the additional words. Based on the first group being associated with the first sense, and including more hypernyms associated with the additional words than the second group, the sense selection engine 134 may select the first sense as the sense for the target word.

As yet another example, for a target word that has a first sense and a second sense: hypernym determination engine 132 may have determined a first group of two hypernyms that are associated with the first sense and have one or more associations to one or more of the additional words; and hypernym determination engine 132 may have determined a second group that also has two hypernyms that are associated with the second sense and that have one or more associations to one or more of the additional words. Since the first group and the second group both include two hypernyms, the sense selection engine 134 may consider one or more additional factors in selecting either the first sense or the second sense for the target word. For example, the sense selection engine 134 may consider weights between the target word and the hypernyms of the group (e.g., weights of hypernyms database 152 that indicate the strengths of the associations of the word to the hypernyms), a popularity measure of each of the senses, etc. For instance, the sense selection engine 134 may select the first sense if the weights of the hypernyms of the first group indicate a stronger association of the target word to those hypernyms than the weights of the hypernyms of the second group.

As yet another example, where hypernym determination engine 132 utilizes a cross product of two vectors (or other techniques) to provide an indication of hypernyms that are associated with each of a plurality of senses and the additional words (if any) and/or the collective similarity between those hypernyms—such indications may be utilized by the sense selection engine 134 to select a sense. For example, the indications may each be a vector (cross product) and the sense selection engine 134 may select one of the senses based on comparison of the vectors. Also, for example, the indications may each be a scalar value (dot product) and the sense selection engine 134 may select one of the senses based on comparison of the scalar values.

A selected sense of a target word in a textual segment may be provided by sense selection engine 134 to one or more other components. For example, the sense may be provided to one or more natural language processing systems or other systems for use in determining additional characteristics of: the textual segment, a larger textual segment in which the textual segment is included, and/or a document in which the textual segment is included. Also, for example, the textual segment may be a search query received from a search system and the sense may be provided to the search system to enable the search system to tailor search results to be more responsive to the sense (e.g., by modifying the search query based on the sense and/or ranking responsive documents based on the sense). Also, for example, the sense may be provided to an advertisement system to enable the advertisement system to tailor advertisements (provided based on the textual segment) to the selected sense. For instance, the textual segment may be a search query and advertisements may be provided responsive to the search query that are tailored based on the sense. Also, for instance, the textual segment may be included in a webpage and advertisements may be provided for display with the webpage that are tailored based on the sense. Also, for example, the textual segment may be from a document being viewed and/or edited in a program executing on a client device and the sense may be provided to the program to enable the program to tailor provided content based on the sense.

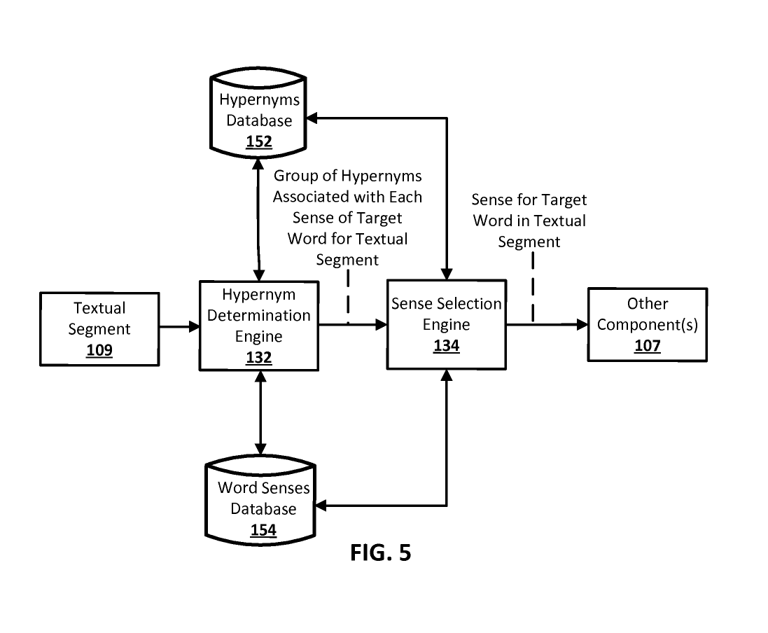

With reference to FIG. 5, an example is provided of how a sense for a target word in a textual segment may be determined. Hypernym determination engine 132 may identify a textual segment 109 from one or more resources of resource database and/or from another source (e.g., from a client device). Hypernym determination engine 132 may further identify a target word to be disambiguated in the textual segment 109.

In some implementations, hypernym determination engine 132 may determine whether to disambiguate a target word based on determining whether the target word is associated with an indication that disambiguation is unnecessary. For example, as described above, word senses system 120 may associate certain words with an indication that disambiguation of the word is unnecessary. In some implementations, hypernym determination engine 132 may determine whether to disambiguate a target word based on determining target hypernyms for the target word in hypernyms database 152, determining one or more similarity measures between the target hypernyms fail to satisfy a threshold, and only disambiguating the target word when the similarity measures fail to satisfy a threshold. For example, in some implementations, the hypernyms database 152 and/or another database includes an embedding of hypernyms in a k-dimensional space. In some versions of those implementations, the hypernym determination engine 132 may generate a vector indicating the hypernyms of a target word (e.g., hypernyms of: the target word, definitional words in senses (if any) of the target word, and/or hypernyms of the definitional words). The vector may be applied to the k-dimensional space to determine one or more similarity measure(s) between the hypernyms (either individual similarity measures or a collective similarity measure). If the similarity measure satisfies a threshold, it may indicate the target word is not sufficiently ambiguous to warrant disambiguation.

For each of one or more senses of the target word in textual segment 109, hypernym determination engine 132 determines a group (if any) of one or more hypernyms that are associated with the sense and that are associated with one or more additional words of the textual segment. The hypernym determination engine 132 provides, for each of one or more senses of the target word, a group (if any) of one or more hypernyms that are associated with the sense and that are associated with one or more additional words of the textual segment to sense selection engine 134. The sense selection engine 134 selects one of the senses based on the provided indications. For example, the sense selection engine 134 selects the sense associated with the group having the largest indication of hypernyms. The sense selection engine 134 provides the selected sense to one or more other components 107.

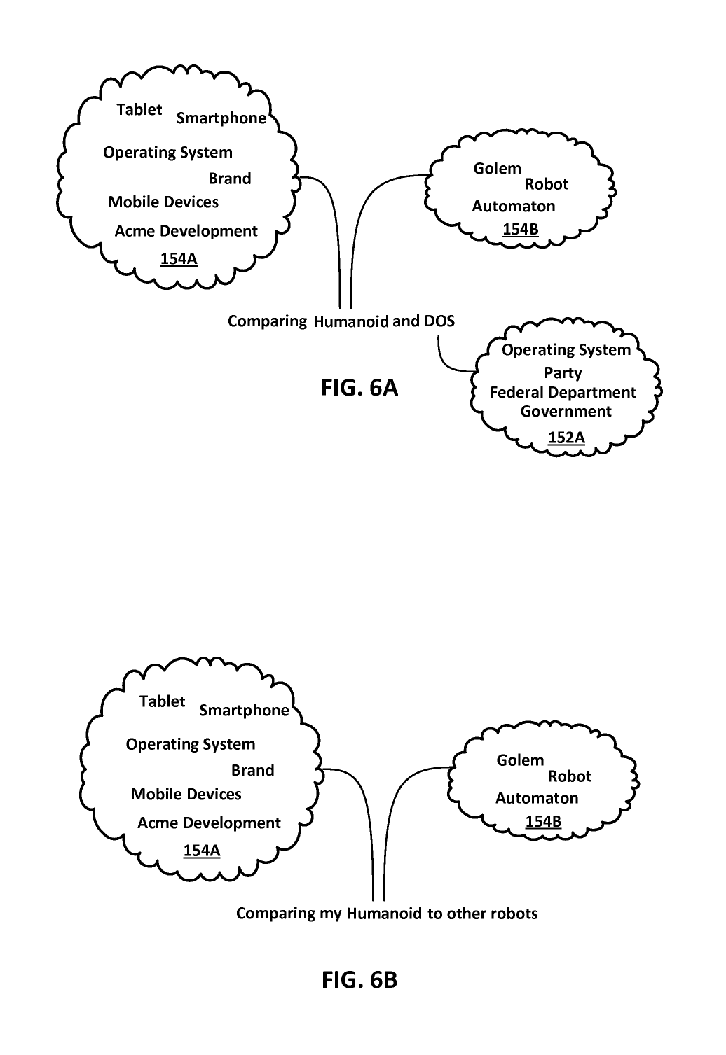

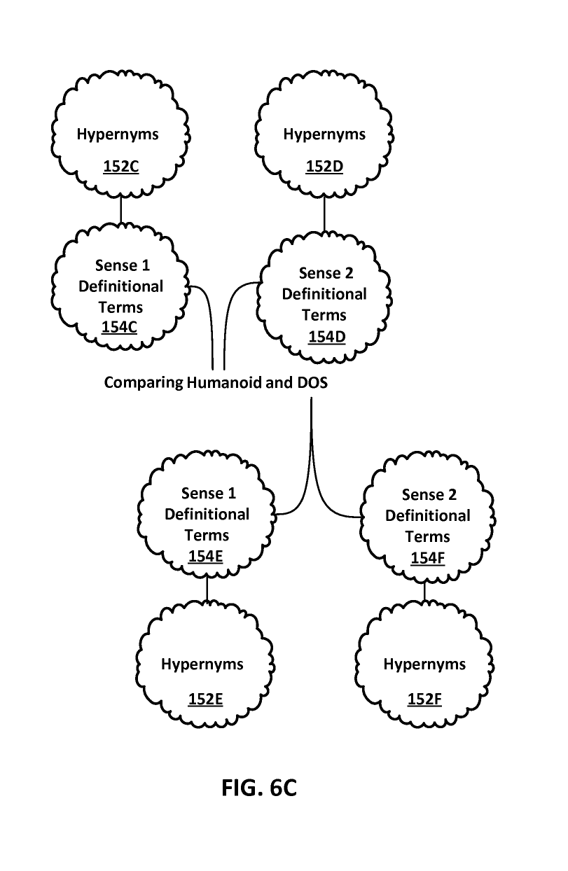

As one specific example, the textual segment 109 may be “Comparing Humanoid and DOS” as illustrated in FIG. 6A. Hypernym determination engine 132 may identify “Humanoid” as a target word to be disambiguated in the textual segment. Hypernym determination engine 132 may identify a first sense 154A of “Humanoid” from word senses database 154 that indicates a group of hypernyms associated with the sense such as “tablet”, “smartphone”, “operating system”, etc. Hypernym determination engine 132 may also identify a second sense 154B of “Humanoid” from word senses database 154 that indicates a group of hypernyms associated with the sense such as “golem”, “robot”, and “automaton”. In some implementations, the senses 154A, 154B and associated hypernyms may be defined by word senses system 120 as described herein.

Hypernym determination engine 132 may also identify hypernyms for one or more additional words of the textual segment from hypernyms database 152. For example, as illustrated in FIG. 6A, the hypernym determination engine 132 may identify hypernyms 152A as hypernyms of “DOS”. The hypernyms include “operating system” (associated with the computer operating system meaning), “party” (associated with the uproarious party meaning), federal government, and government (associated with the Department of Justice meaning).

For each of the two senses 154A, 154B of “humanoid”, hypernym determination engine 132 determines a group (if any) of one or more hypernyms that are associated with the sense and associated with the additional words of the textual segment “Comparing Humanoid and DOS”. For example, hypernym determination engine 132 may determine a first group of “Operating System” that is associated with the sense 154A and the word “DOS”. Hypernym determination engine 132 may also determine that no hypernyms are associated with the sense 154B and the word “DOS”.

The hypernym determination engine 132 provides an indication to sense selection engine 134 that one hypernym (“Operating System”) is associated with both the sense 154A and the additional words and that no hypernyms are associated with both the sense 154B and the additional words. The sense selection engine 134 selects the sense 154A based on the provided indication. For example, the sense selection engine 134 selects the sense 154A based on it having the largest indication of hypernyms. The sense selection engine 134 provides the selected sense to one or more other components 107.

As another example, with reference to FIG. 6B, the textual segment 109 may be “Comparing my Humanoid to other robots” as illustrated in FIG. 6B. Hypernym determination engine 132 may identify “Humanoid” as the target word to be disambiguated in the textual segment. Hypernym determination engine 132 may identify a first sense 154A of Humanoid from word senses database 154 and a second sense 154B of Humanoid from word senses database 154 as described above with respect to FIG. 6A.

For each of the two senses 154A, 154B of “humanoid”, hypernym determination engine 132 determines a group (if any) of one or more hypernyms that are associated with the sense and the additional words of the textual segment “Comparing my Humanoid to other robots”. For example, hypernym determination engine 132 may determine a first group of “robot” that is associated with the sense 154B and the additional word “robots” in the textual segment of FIG. 6B. Hypernym determination engine 132 may also determine that no hypernyms are associated with the sense 154A and additional words of the textual segment.

The hypernym determination engine 132 provides an indication to sense selection engine 134 that one hypernym (“robot”) is associated with both the sense 154B and the additional words and that no hypernyms are associated with both the sense 154A and the additional words. The sense selection engine 134 selects the sense 154B based on the provided indications. For example, the sense selection engine 134 selects the sense 154B based on it having the largest indication of hypernyms. The sense selection engine 134 provides the selected sense to one or more other components 107.

As yet another example, with reference to FIG. 6C, the textual segment 109 may be “Comparing Humanoid and DOS” as illustrated in FIG. 6C. Hypernym determination engine 132 may identify “Humanoid” as the target word to be disambiguated in the textual segment. Hypernym determination engine 132 may identify first sense definitional terms 154C of “Humanoid” from word senses database 154 and second sense definitional terms 154D of “Humanoid” from word senses database 154. First sense definitional terms 154C may include those in a first sense definition included for the word in an electronic sense dictionary of words sense database 154 and second sense definitional terms 154D may include those in a second sense definition included for the word in the electronic sense dictionary. In some implementations, the electronic sense dictionary may be manually curated and/or created utilizing techniques other than those described herein with respect to word senses system 120.

Based on the first sense definitional terms 154C, hypernym determination engine 132 determines hypernyms 152C for those terms from hypernyms database 152. Likewise, based on the second sense definitional terms 154D, hypernym determination engine 132 determines hypernyms 152D for those terms from hypernyms database 152.

Hypernym determination engine 132 may also identify sense definitional terms and hypernyms for one or more additional words of the textual segment. For example, as illustrated in FIG. 6C, the hypernym determination engine 132 may identify first sense definitional terms 154E of “DOS” from word senses database 154 and second sense definitional terms 154F of “DOS” from word senses database 154. First sense definitional terms 154E may include those in a first sense definition included for the word in an electronic sense dictionary of words sense database 154 and second sense definitional terms 154F may include those in a second sense definition included for the word in the electronic sense dictionary.

Based on the first sense definitional terms 154E, hypernym determination engine 132 determines hypernyms 152E for those terms from hypernyms database 152. Likewise, based on the second sense definitional terms 154F, hypernym determination engine 132 determines hypernyms 152F for those terms from hypernyms database 152.

For each of the two senses of “Humanoid”, hypernym determination engine 132 determines a group (if any) of one or more hypernyms that are associated with the sense and the additional words of the textual segment “Comparing Humanoid and DOS”. For example, hypernym determination engine 132 may determine a first group of hypernyms that are associated with the hypernyms 152C of the first sense and with one or more of the definitional terms 154E, 154F and/or hypernyms 152E, 152F associated with the word “DOS”. Hypernym determination engine 132 may determine that no hypernyms are associated with the second sense of “Humanoid” and with additional words of the textual segment.

The hypernym determination engine 132 provides an indication to sense selection engine 134 that a first group of hypernyms is associated with the first sense of “Humanoid” and the sense selection engine 134 selects that sense based on the provided indication. The sense selection engine 134 provides the selected sense to one or more other components 107. Different techniques are described above with respect to each of FIGS. 6A, 6B, and 6C. However, in some implementations, disambiguation system may combine all or aspects of techniques described with respect to those figures (and/or additional techniques) in disambiguating a target word. Also, although only disambiguation of a single target word is described above with respect to each of FIGS. 6A, 6B, and 6C, it is understood that two or more words may be disambiguated in a segment in various implementations.

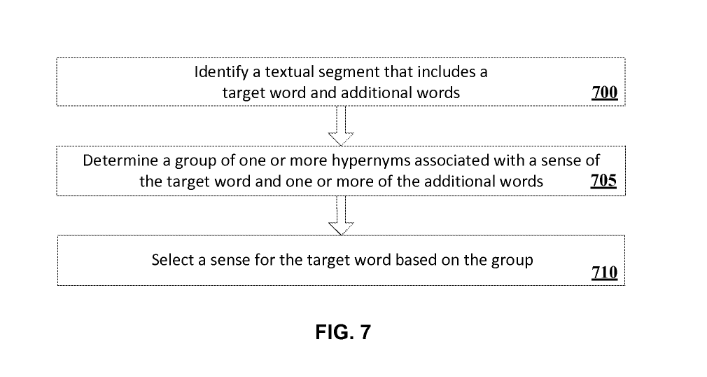

FIG. 7 is a flow chart illustrating an example of determining a sense for a target word in a textual segment. For convenience, the operations of the flow chart are described with reference to a system that performs the operations. This system may include various components of various computer systems. For instance, some operations may be performed by one or more components of the disambiguation system 130, such as hypernym determination engine 132 and sense selection engine 134. Moreover, while operations of the method of FIG. 7 are shown in a particular order, this is not meant to be limiting. One or more operations may be reordered, omitted or added.

At step 700, a textual segment is identified that includes a target word and additional words. For example, the system may identify a textual segment from one or more resources of resource database 158 and/or from another source (e.g., from a client device). The system may further identify a target word to be disambiguated in the textual segment.

At step 705, a group of one or more hypernyms is determined that is associated with a sense of the target word and that is associated with one or more of the additional words. For example, the system may determine, for each of one or more senses of the target word, a group (if any) of one or more hypernyms that are associated with the sense and that are associated with one or more additional words of the textual segment. In some implementations, the senses for the target word and/or the hypernyms associated with the senses may be defined by word senses system 120 as described herein.

At step 710, a sense is selected for the target word based on the group. For example, at step 705 the system may determine, for each of the senses of the target word, a group of hypernyms (if any) that are associated with the sense. The system may select one of the senses based on the determined groups. For example, system may select the sense associated with the group having the largest indication of hypernyms. The system may provide the selected sense to one or more other components.

In this specification, the term “database” will be used broadly to refer to any collection of data. The data of the database does not need to be structured in any particular way, or structured at all, and it can be stored on storage devices in one or more locations. Thus, for example, the databases 152, 154, and/or 158 may each include multiple collections of data, each of which may be organized and accessed differently. Also, for example, all or portions of the databases 152, 154, and/or 158 may be combined into one database and/or may contain pointers and/or other links between entries in the database(s). Also, in this specification, the term “entry” will be used broadly to refer to any mapping of a plurality of associated information items. A single entry need not be present in a single storage device and may include pointers or other indications of information items that may be present on other storage devices. For example, an entry that identifies a word and associated hypernyms in hypernyms database 152 may include multiple nodes mapped to one another, with each node including an identifier of an entity or other information item that may be present in another data structure and/or another storage medium.

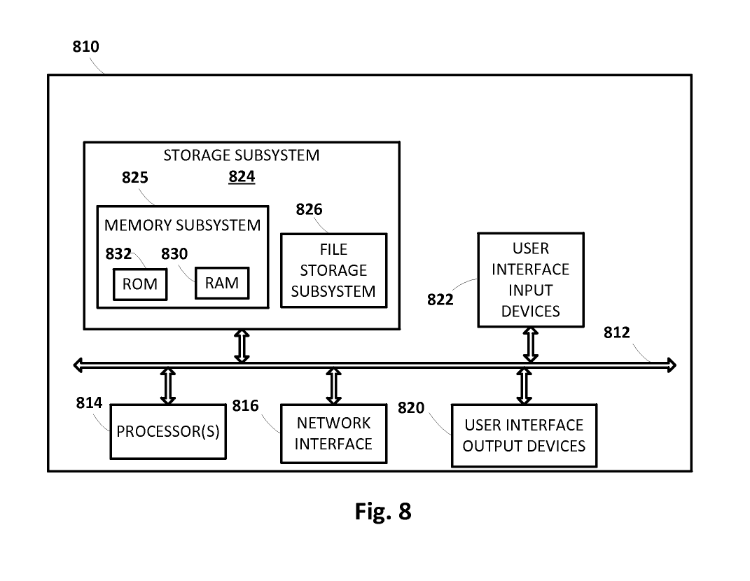

FIG. 8 is a block diagram of an example computer system 810. Computer system 810 typically includes at least one processor 814 which communicates with a number of peripheral devices via bus subsystem 812. These peripheral devices may include a storage subsystem 824, including, for example, a memory subsystem 825 and a file storage subsystem 826, user interface output devices 820, user interface input devices 822, and a network interface subsystem 816. The input and output devices allow user interaction with computer system 810. Network interface subsystem 816 provides an interface to outside networks and is coupled to corresponding interface devices in other computer systems.

User interface input devices 822 may include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term “input device” is intended to include all possible types of devices and ways to input information into computer system 810 or onto a communication network.

User interface output devices 820 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computer system 810 to the user or to another machine or computer system.

Storage subsystem 824 stores programming and data constructs that provide the functionality of some or all of the modules described herein. For example, the storage subsystem 824 may include the logic to perform selected aspects of the method of FIG. 4, as well as one or more of the operations performed by hypernym clustering engine 122 and/or senses engine 124. Also, for example, the storage subsystem 824 may additionally and/or alternatively include the logic to perform selected aspects of the method of FIG. 7, as well as one or more of the operations performed by hypernym determination engine 132 and/or sense selection engine 134.

These software modules are generally executed by processor 817 alone or in combination with other processors. Memory 825 used in the storage subsystem can include a number of memories including a main random access memory (RAM) 830 for storage of instructions and data during program execution and a read only memory (ROM) 832 in which fixed instructions are stored. A file storage subsystem 826 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 826 in the storage subsystem 827, or in other machines accessible by the processor(s) 817.

Bus subsystem 812 provides a mechanism for letting the various components and subsystems of computer system 810 communicate with each other as intended. Although bus subsystem 812 is shown schematically as a single bus, alternative implementations of the bus subsystem may use multiple busses.

Computer system 810 can be of varying types including a workstation, server, computing cluster, blade server, server farm, or any other data processing system or computing device. Due to the ever-changing nature of computers and networks, the description of computer system 810 depicted in FIG. 8 is intended only as a specific example for purposes of illustrating some implementations. Many other configurations of computer system 810 are possible having more or fewer components than the computer system depicted in FIG. 8.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

1. A computer implemented method, comprising:
determining, by one or more computing systems, a plurality of hypernyms for a word, each of the hypernyms including the word and one or more additional words as associated members;
clustering, by one or more of the computing systems, the hypernyms into one or more groups based on similarity measures between the hypernyms;
defining, by one or more of the computing systems, one or more senses of the word based on the groups;
storing, by one or more of the computing systems in one or more databases, an association of the word to the senses;
identifying, by one or more of the computing systems, a search query that includes the word and a plurality of additional words;
selecting, by one or more of the computing systems, one sense for the word in the search query, the one sense being one of the senses and being selected based on the association of the word to the one sense; and
tailoring, by a search system of the one or more of the computing systems and based on the selected one sense, content that is responsive to the search query, tailoring the content comprising:
modifying the search query based on the selected one sense and identifying the content by the search system based on the modified search query, or
ranking the content based on the selected one sense; and
providing for display the tailored content by one or more of the computing systems in response to the search query.

2. The method of claim 1, wherein the word is included as an associated member of a given hypernym of the hypernyms based on one or more syntactic relationships between the given hypernym and the word in one or more resources.

3. The method of claim 2, wherein the resources include one or more of:
search queries, webpages, and communications.

4. The method of claim 2, wherein the word fails to have a true taxonomical relationship to the given hypernym.

5. The method of claim 2, wherein the given hypernym defines a sentiment.

6. The method of claim 1, further comprising:
determining the similarity measures between the hypernyms, wherein determining a similarity measure of the similarity measures between a first hypernym and a second hypernym of the hypernyms is based on a degree of overlap between the additional words of the first hypernym and the additional words of the second hypernym.

7. The method of claim 1, further comprising:
determining the similarity measures between the hypernyms, wherein determining a similarity measure of the similarity measures between a first hypernym and a second hypernym of the hypernyms is based on one or more relationships between the first hypernym and the second hypernym in an entity database.

8. The method of claim 1, further comprising:
determining the similarity measures between the hypernyms, wherein determining a similarity measure of the similarity measures between a first hypernym and a second hypernym of the hypernyms is based on one or more syntactic relationships between the first hypernym and the second hypernym in one or more resources.

9. The method of claim 1, wherein the word is included as an associated member of a given hypernym of the hypernyms based on automated process that analyzes relationships between the given hypernym and the word in one or more resources.

10. The method of claim 1, wherein clustering the hypernyms into one or more groups includes clustering the hypernyms into a single group;
and defining the senses of the word based on the group includes defining the word as having only a single sense based on presence of only the single group for the word.

11. The method of claim 10, wherein storing the association of the word to the senses includes associating the word with an indication that disambiguation of the word is unnecessary.

12. The method of claim 1, wherein a given sense of the senses is defined based on a given group of the groups and wherein storing the association of the word to the senses includes storing an association of the given sense with the hypernyms of the given group.

13. (canceled)

14. The method of claim 1, wherein selecting the one sense for the word in the textual segment based on the stored association of the word to the senses comprises:
determining a subset of the hypernyms for the word based on an association of one or more of the additional segment words to the hypernyms of the subset; and
selecting the one sense based on the subset.

15. The method of claim 14, wherein the one sense of the senses is defined based on a given group of the groups and wherein storing the association of the word to the senses includes storing an association of the one sense with the hypernyms of the given group; and wherein selecting the one sense based on the subset includes selecting the one sense based on the hypernyms of the subset being included in the hypernyms of the given group associated with the one sense.

16. The method of claim 14, wherein determining a subset of the hypernyms for the word based on an association of one or more of the additional segment words to the hypernyms of the subset comprises:
determining additional word hypernyms for one or more of the additional segment words;
determining the subset of the hypernyms based on one or both of: one or more of the additional word hypernyms matching one or more of the hypernyms of the subset; and one or more of the additional word hypernyms having at least a threshold similarity measure relative to one or more of the hypernyms of the subset.

17. A computer implemented method, comprising:
identifying, by one or more computing systems, a textual segment including a target word and a plurality of additional words, the textual segment being viewed or edited in a program executing on a client device of a user;
determining, by a hypernym determination engine of one or more of the computing systems, a group of one or more hypernyms associated with a sense of the target word and associated with one or more of the additional words, wherein determining the group of the one or more hypernyms comprises:
determining at least a first hypernym of the one or more hypernyms of the group based on the hypernym being a hypernym of one or more definitional words in a sense definition of one of the additional words;
selecting, by a sense selection engine of one or more of the computing systems, a sense for the target word based on the group;
tailoring, by one or more of the computing systems and based on the selected sense, content associated with the textual segment, tailoring the content comprising:
modifying the textual segment based on the selected sense and identifying the content based on the modified textual segment, or
ranking the content based on the selected sense; and
providing the content for display to the user via the client device.

18. The method of claim 17, further comprising:
determining target hypernyms for the target word, each of the target hypernyms including the word as an associated member; and
determining one or more similarity measures between the target hypernyms fail to satisfy a threshold;
wherein selecting the sense for the target word based on the group is based on the similarity measures failing to satisfy the threshold.

19. The method of claim 17, wherein determining the group of the one or more hypernyms associated with a sense of the target word and associated with one or more of the additional words comprises:
determining at least a second hypernym of the hypernyms of the group based on the hypernym being one of the additional words.

20. The method of claim 17, wherein determining the group of the one or more hypernyms associated with a sense of the target word and associated with one or more of the additional words comprises:
determining at least a second hypernym of the hypernyms of the group based on the hypernym being a hypernym of one of the additional words.

21. (canceled)

22. The method of claim 17, wherein determining the group of the one or more hypernyms associated with a sense of the target word and associated with one or more of the additional words comprises:
determining at least a second hypernym of the hypernyms of the group has a similarity measure that satisfies a threshold, the similarity measure indicative of similarity between the second hypernym and a third hypernym that is associated with one or more of the additional words;
wherein the third hypernym is not included in the group.

23. The method of claim 22, wherein the similarity measure is a distance measure in an embedding of hypernyms in a k-dimensional space.

24. The method of claim 23, wherein the embedding of the hypernyms in the k-dimensional space is learned based on relationships between the hypernyms and the target word in one or more resources.

25. The method of claim 17, wherein determining the group of the one or more hypernyms associated with a sense of the target word and associated with one or more of the additional words comprises:
determining the hypernyms are associated with the sense of the target word based on the hypernyms including one or more definitional words in a definition of the sense of the target word.

26. The method of claim 17, wherein determining the group of the one or more hypernyms associated with a sense of the target word and associated with one or more of the additional words comprises:
determining the hypernyms are associated with the sense of the target word based on the hypernyms being included in a definition of the sense of the target word.

27. A computer implemented method, comprising:
determining, by one or more computing systems, a plurality of hypernyms for a word, each of the hypernyms including the word and one or more additional words as associated members;
clustering, by a hypernym clustering engine of one or more of the computing systems, the hypernyms into one or more groups based on similarity measures between the hypernyms;
defining, by a word senses engine of one or more of the computing systems, one or more senses of the word based on the groups;
storing, by one or more of the computing systems in one or more databases, an association of the word to the senses;
receiving, by one or more of the computing systems, a textual segment that includes the word and a plurality of additional words, wherein receiving the textual segment is in response to the textual segment being viewed or submitted via a program executing on a client device of a user; and
selecting, by a sense selection engine of one or more of the computing systems, a sense for the word in the textual segment, the sense being one of the senses and being selected based on the association of the word to the sense;
in response to receiving the textual segment, providing the sense, or content tailored based on the sense, to the program executing on the client device.
